(19) United States
(12) Patent Application Publication
(10) Pub. No.: US 2019/0039144 A1
(43) Pub. Date: Feb. 7, 2019

(54) Tailstock Device for Supporting and/or Centering a Workpiece

(71) Applicant: Walter Maschinenbau GmbH, Tübingen (DE)

(72) Inventors: Dominik Held, Dußlingen (DE); Ivan Stastný, Kurim (CZ)

(21) Appl. No.: 15/758,943

(22) PCT Filed: Aug. 24, 2016
(86) PCT No.: PCT/EP2016/069945

§ 371 Date: Mar. 9, 2018

(30) Foreign Application Priority Data
Sep. 10, 2015 (DE) 10 2015 115 206.1

(51) Int. Cl. B23B 23/00; B24B 5/04; B24B 41/06

(52) U.S. Cl. CPC B23B 23/005; B24B 41/062; B24B 5/04

(57) ABSTRACT

The invention relates to a tail stock device (10) for supporting a workpiece in a machine tool, for example a grinding machine. The tail stock device (10) comprises a tail stock arm (16) that is pivotally supported about a pivot axis (S), said tail stock arm having arranged on its outer end (16a) a centering tip (12) that is oriented parallel to the pivot axis (S). By means of a pivot drive (30) comprising a first pneumatic cylinder (31), the tail stock arm 16 can be pivoted between a working position (A) and a resting position (R). The movement of the piston (32) of the first pneumatic cylinder (31) is transmitted—via a first coupling arrangement (35)—to the tail stock arm (16). When the tail stock arm (16) is in working position (A), the first coupling arrangement (35) assumes a self-locking position in which a force feedback effect being triggered by a torque that forces the tail stock arm (16) out of working position (A) and into resting position (R) does not or only minimally retroact on the piston (32) of the first pneumatic cylinder (31).

The invention relates to a tail stock device for supporting and/or centering a workpiece. In processing machines, tail stocks are in particular disposed for supporting the end of a workpiece, preferably the face of the workpiece relative to the chuck.

For example, a tail stock for a grinding machine has been known from document DE 3517802 A1. The tail stock has a tail stock lower part and a tail stock upper part that are connected to each other so that they can be pivoted about a pivot axis. For performing the pivoting motion, the tail stock comprises a pivot drive. Via the pivot drive it is possible for the tail stock upper part bearing the support arrangement for the workpiece to be moved into or out of a working region of a grinding disk. In doing so, the sleeve axis of the tail stock extends tangentially with respect to the pivot axis.

The space requirement of such a tail stock device is great. Even if the tail stock upper part is pivoted out of the working region, this part still requires considerable machine space.

Considering this prior art, it can be viewed as the object of the present invention to provide a tail stock device that can be configured and actuated in a simple manner and makes possible a space-saving implementation.

This object is achieved with a tail stock device displaying the features of patent Claim 1.

The tail stock device comprises a carrier arrangement. The carrier arrangement is disposed to be connected to a machine tool and comprises, e.g., appropriate mounting means for this purpose. A tail stock arm is provided on the carrier arrangement. The inner end of the tail stock arm is supported by the carrier arrangement so that said arm can be pivoted about a pivot axis. On the outer end opposite the inner end the tail stock arm comprises a support arrangement. The support arrangement may comprise a centering tip that interacts with a central bore in the face of the workpiece in order to support and/or center the workpiece.

Furthermore, a pivot drive is provided on the carrier arrangement. The pivot drive comprises a first pneumatic cylinder and a first coupling arrangement. A piston of the first pneumatic cylinder is movably coupled with the inner end of the tail stock arm via the first coupling arrangement. With the use of the pivot drive, the tail stock arm can be moved between an erect working position and a lying resting position, preferably within a pivot angle range of at most 90° to 100°. In doing so, the first coupling arrangement is configured in such a manner that it at least reduces or completely eliminates any force feedback due to a type of self-locking effect whenever a torque about the pivot axis is exerted while the tail stock arm is in working position, said torque displacing the tail stock arm out of its working position in the direction of the resting position.

Thus it can be avoided that the compressible air of the pneumatic cylinder causes the tail stock not to remain in its working position. The stiffness of the arrangement is sufficiently high in this manner to maintain an exact positioning of the tail stock arm in its working position. An inadvertent pivoting back out of the working position in the direction of the resting position is prevented.

It is advantageous if the first coupling arrangement comprises a pivot lever that is connected in a torque-proof manner to the inner end of the tail stock arm and extends from the pivot axis toward one lever end. Furthermore, the first coupling arrangement may comprise a connecting member that is rotatably connected to the lever end by means of a first hinge. Furthermore, the connecting member may be rotatably connected to an actuating element via a second hinge. The actuating element, in turn, is preferably rigidly connected to the piston of the first pneumatic cylinder in a longitudinal direction in which the piston can move back and forth. In accordance with the example, the longitudinal direction is oriented at a right angle with respect to the pivot axis. In doing so, the first coupling arrangement forms a lever mechanism. Preferably, the actuating element comprises only one degree of freedom in longitudinal direction. Said actuating element may be connected to a piston rod of the first pneumatic cylinder.

In doing so, it is advantageous—in working position of the tail stock arm—if the connecting member is substantially oriented at a right angle with respect to the tail stock. The phrase “substantially oriented at a right angle” is to be understood to mean a right angle that corresponds approximately to 90° and may be within the range between 80° and 100°, for example.

Furthermore, it is advantageous if the connecting member—in working position of the tail stock arm—is oriented substantially at a right angle with respect to the actuating element.

Preferably, the connecting member extends—in working position of the tail stock arm—approximately parallel to the tail stock arm or at an acute angle that has a value of a maximum of 5° or a maximum of 10° or a maximum of 15°.

By orienting the connecting member in the working position of the tail stock arm it is possible, when a torque is applied to the tail stock arm about its pivot axis, to almost or completely eliminate a force feedback in the direction toward the piston of the first pneumatic cylinder. If the connecting member is positioned at a right angle or almost at a right angle with respect to the longitudinal direction, no or only a minimal force can be transmitted by the torque of the tail stock arm to the actuating element, so that a compression of the air in the pneumatic cylinder can be precluded. The results in great stiffness of the arrangement in the working position of the tail stock arm.

Preferably, the actuating element can be moved only within one degree of freedom and is arranged in the exemplary embodiment so that it can be shifted in a longitudinal direction on the carrier arrangement.

Considering a preferred exemplary embodiment, the tail stock device comprises a stop that is provided in the carrier arrangement or formed by the carrier arrangement. In working position of the tail stock arm, the pivot drive forces the tail stock arm against the stop. The stop is preferably associated with the inner end of the tail stock arm.

Furthermore it is preferred if the carrier arrangement comprises a base body that is designed for the connection with the machine tool. To this end, an appropriate mounting means may be present on the base body. Preferably, a carriage can be moved within a single degree of freedom on the base body. For example, the carriage may be supported by the base body so as to be slidable. For example, the carriage can be supported so as to be slidable in a transverse direction at a right angle with respect to the longitudinal direction by means of a guiding arrangement. The guiding arrangement may comprise pre-tensioned cross roller guides in order to achieve play-free guiding. In accordance with the example, the transverse direction is oriented parallel to the pivot axis.

In the working position, the tail stock arm extends preferably in a height direction at a right angle with respect to the longitudinal direction and at a right angle with respect to the transverse direction—originating from the pivot axis—toward its outer end.

The tail stock arm and the pivot drive may be arranged on the carriage and move, together with the carriage, relative to the base body.

In a preferred exemplary embodiment a linear drive is provided for moving the carriage, said linear drive comprising a second pneumatic cylinder and a second coupling arrangement. With the aid of the linear drive, it is possible to move or position the carriage relative to the base body.

Consequently, the linear drive as well as the pivot drive can be pneumatically actuated.

The second coupling arrangement preferably comprises a gate part with a gate defining the gate path. A gate element is arranged so as to be movable along the gate path. With the aid of this embodiment of the second coupling arrangement it is very easy to achieve a reduction concerning the path of a piston of the second pneumatic cylinder relative to a movement of the carriage.

Preferably, the gate element is immovably arranged on the base body and extends into the slotted gate. In doing so, it can engage through the carriage through a corresponding recess. The gate element is supported so that it can be slid in longitudinal direction along the carriage. The gate element, the carriage and the base body form—so to speak—a cross carriage arrangement.

It is preferred if a piston of the second pneumatic cylinder can be moved in longitudinal direction, in which case the gate part can be connected to the piston of the second pneumatic cylinder so as to be immovable in longitudinal direction. Preferably, the gate part is arranged only within one degree of freedom and, in accordance with the example, is arranged on the carriage or on the base body so as be movable in longitudinal direction. The carriage is supported at a right angle relative to the longitudinal direction so as to be movable in transverse direction on the base body.

In a preferred exemplary embodiment, the second pneumatic cylinder and the gate part are arranged on the carriage and move together with the carriage in transverse direction relative to the base body.

In particular, the gate path is arranged obliquely with respect to the longitudinal direction and obliquely with respect to the transverse direction. Preferably, the gate path and the longitudinal direction subtend an angle of inclination that is constant, for example. The angle of inclination is preferably smaller than 45° in order to achieve a reduction of the path from the second pneumatic cylinder to the carriage. Due to this angle of inclination a force transmission from the second pneumatic cylinder is achieved in addition to the reduction of the path. It is preferred if the angle of inclination is a maximum of 30° or maximum of 20° or a maximum of 10°. Consequently, it is possible to achieve very good motion control of the carriage due to the volume flow of the air, without triggering jerky carriage movements.

Advantageous embodiments of the tail stock device can be inferred from the dependent claims, the description and the drawings. Hereinafter, preferred exemplary embodiments of the tail stock device are explained in detail with reference to the attached drawings. They show in

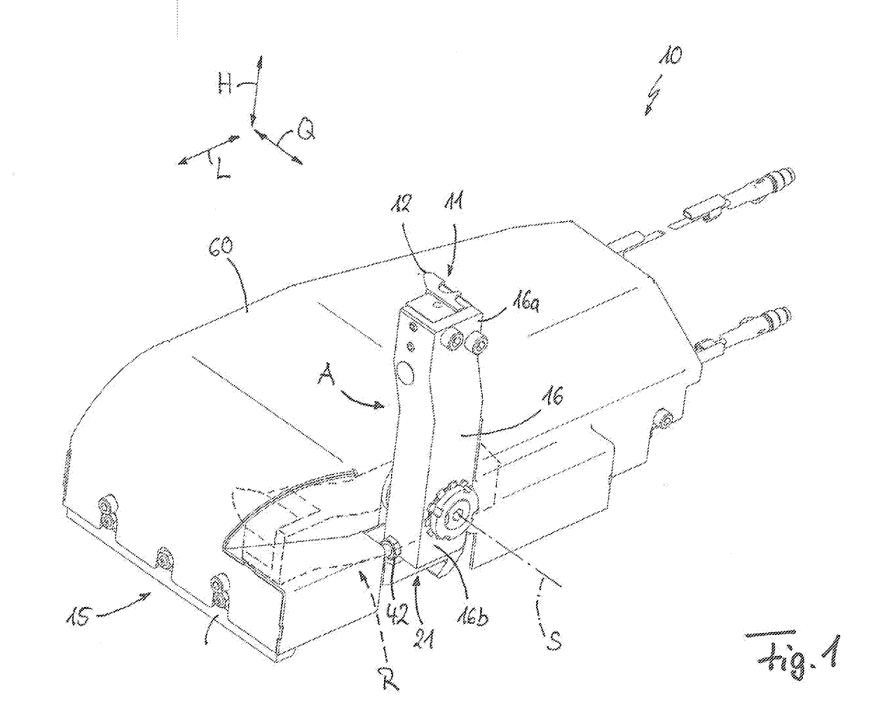

FIG. 1 a perspective representation of an exemplary embodiment of the tail stock device;

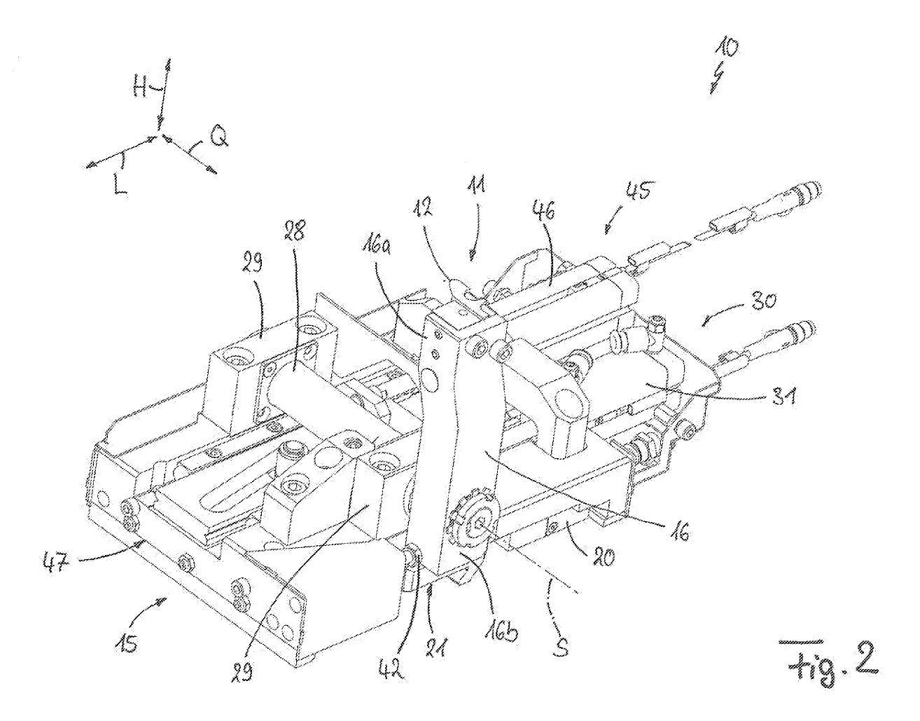

FIG. 2 the same perspective view of the exemplary embodiment according to FIG. 1, without cover;

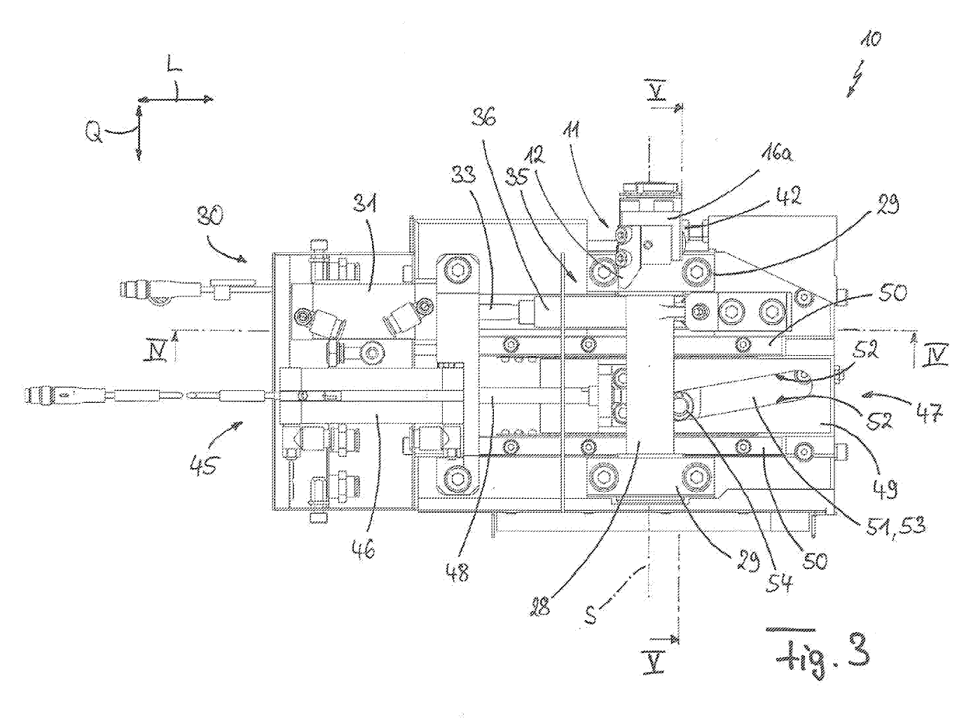

FIG. 3 a plan view of the tail stock device according to FIG. 2, without cover;

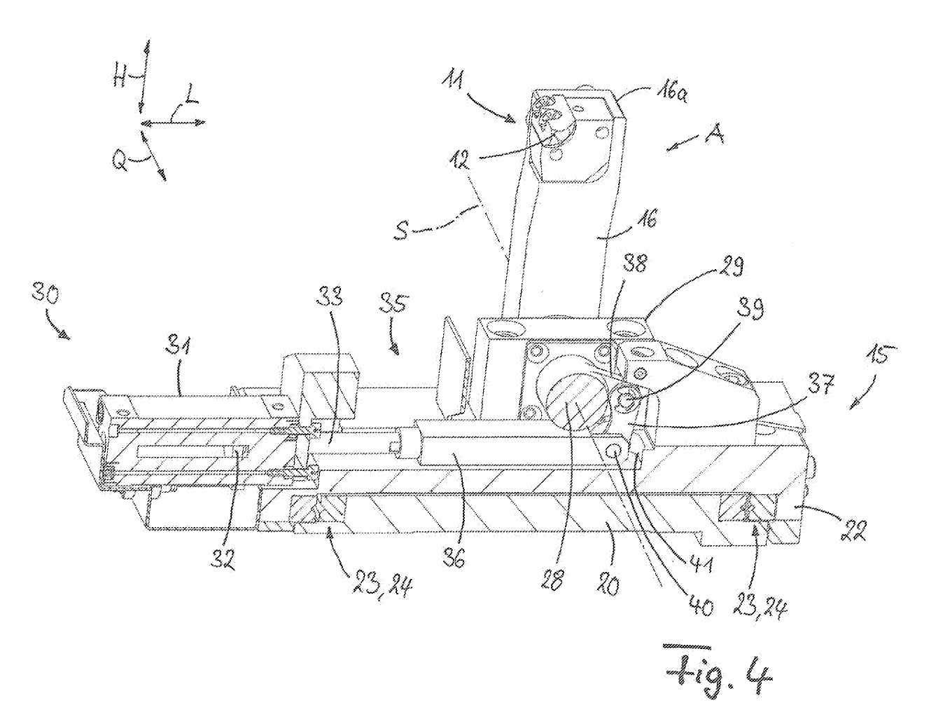

FIG. 4 a perspective sectional representation through the tail stock device according to FIGS. 1-3, along a section line IV-IV in FIG. 3;

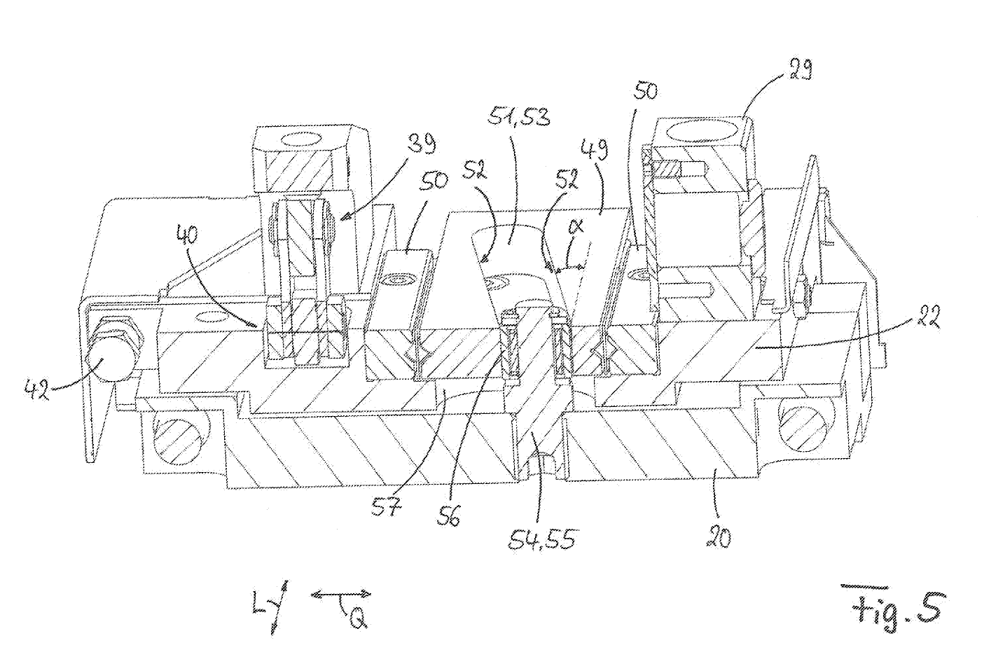

FIG. 5 a perspective sectional partial view of the exemplary embodiment of the tail stock device according to FIGS. 1-4, along section line V-V in FIG. 3; and

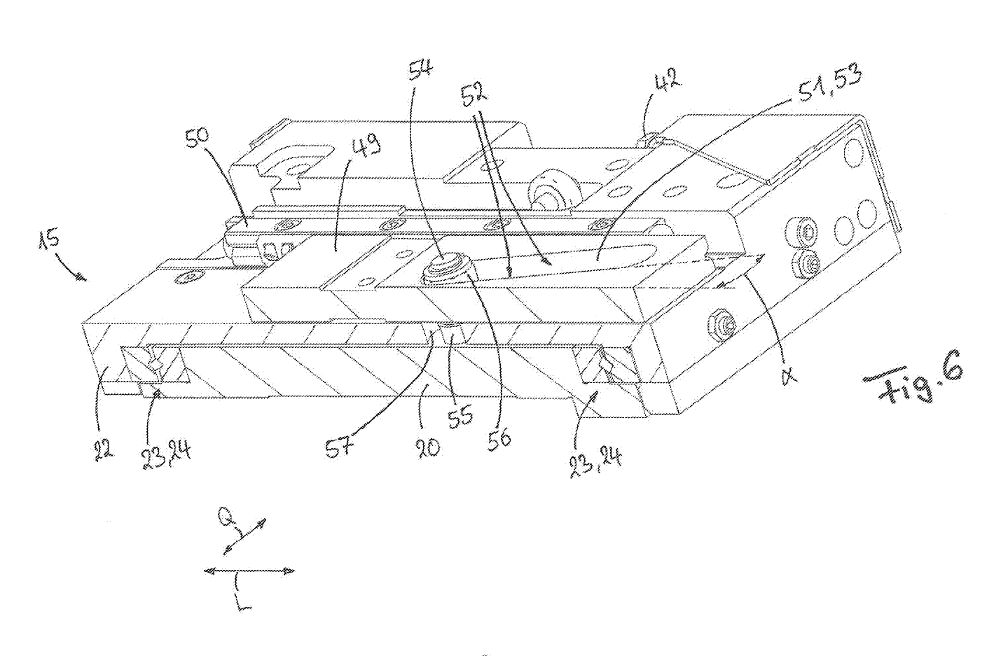

FIG. 6 a perspective sectional representation through a carrier arrangement of the exemplary embodiment of the tail stock device according to FIGS. 1-5, at a right angle with respect to a transverse direction.

FIG. 1 shows an exemplary embodiment of a tail stock device 10. FIG. 1 shows the complete tail stock device 10 for installation on a machine tool. The tail stock device 10 is disposed for supporting and/or centering a workpiece, in particular a cylindrical workpiece. To accomplish this, the tail stock device 10 comprises a support arrangement 11 which—in the exemplary embodiment—has or is formed by a centering tip 12.

The tail stock device 10 comprises a carrier arrangement 15 on which a tail stock arm 16 is arranged so as to be able to pivot about a pivot axis S. In the exemplary embodiment, the tail stock arm 16 can be pivoted about the pivot axis S by approximately 90° between a working position A and a resting position R (FIG. 1). In the working position A, the tail stock arm 16 extends in height direction H away from the pivot axis S up to an outer end 16a toward the tail stock arm 16. The support arrangement 11 or the centering tip 12 is arranged on this outer end 16a. The tail stock arm 16 is supported on the inner end 16b so that it can be pivoted about pivot axis S. Looking at the inner end 16b from the direction of the outer end 16a, the inner end 16b extends beyond the pivot axis S. In the exemplary embodiment, the pivot axis S extends in a transverse direction Q at a right angle with respect to the height direction H.

In accordance with the example, the carrier arrangement 15 comprises a base body 20 that is disposed to be detachably connected to the machine tool and, for example, to a machine bed. To accomplish this, a mounting arrangement 21 is provided on the base body 20. A carriage 22 is arranged on the base body 15 in such a manner that said carriage can be linearly slid in transverse direction. A guiding arrangement 23 for guiding the carriage 22 can be seen in FIGS. 4 and 6. The guiding arrangement 23 comprises two rail guides 24 arranged spaced apart in a longitudinal direction L at a right angle with respect to the transverse direction Q and the height direction H. The rail guides 24 are configured for play-free guiding of the carriage 22 on the base body 20 and are formed, for example, by pre-tensioned cross roller guides.

A shaft 28 is rotatably supported along the pivot axis S on the carriage 22 of the carrier arrangement 15. The shaft 28 is rotatably supported by two bearing points that are spaced apart in accordance with the example along the pivot axis, i.e., respectively by means of a pivot bearing in a pivot bearing body 29. The two pivot bearing bodies 29 are mounted to the carriage 22.

A pivot drive 30 is disposed for pivoting the tail stock arm 16. The pivot drive 30 comprises a first pneumatic cylinder 31 that is configured as a double-acting cylinder. A piston 32 (FIG. 4) of the first pneumatic cylinder 31 fluidically divides the cylinder chamber into two working chambers. The piston 32 is connected to a piston rod 33 of the first pneumatic cylinder 31. The piston rod 33 projects from the cylinder housing. The piston 32 and the piston rod 33 of the first pneumatic cylinder 31 are supported by the carriage 22 so as to be movable in longitudinal direction L.

The piston rod 33 belongs to a first coupling arrangement 35, by mans of which the piston 32 is movably coupled with the tail stock arm 16. The first coupling arrangement 35 can be seen in FIG. 4, in particular. An actuating element 36 is connected to the piston rod 33 of the first pneumatic cylinder 31 in such a manner that the actuating element 36 and the piston rod 33 cannot be moved relative to each other in longitudinal direction L. On the side opposite the piston rod 33, the actuating element 36 is coupled with a pivot lever 38 by means of a connecting member 37. The pivot lever 38 can be pivoted about the pivot axis S and extends, originating from the pivot axis S, toward a lever end. Provided on this lever end there is a first hinge 39 by means of which the connecting member 37 can be linked to the pivot lever 38 in a rotatable manner. A second hinge 40 connects the actuating element 36 to the connecting member 37 in a rotatable manner. The two hinge axes of the hinges 39, 40 are oriented parallel to the pivot axis S. A chain link, for example, may act as the connecting member 37.

Preferably, the actuating element 36 can be moved only within one degree of freedom in longitudinal direction L. In the exemplary embodiment, said actuating element is arranged at least partially in a guiding recess 41 in the carriage 22 and can be supported at that location in a guided sliding manner.

The pivot lever 38 is connected in a torque-proof manner to the tail stock arm 16, for example by means of the shaft 28. The pivot lever 38 may be rigidly arranged on the shaft 28 or be an integral part of the shaft 28. The inner end 16b of the tail stock arm 16 is seated on the shaft 28 in a torque-proof manner and rotates together with the shaft 28 about the pivot axis S.

FIG. 4 shows the working position A of the tail stock arm 16. The piston rod 33 is moved out of the housing of the first pneumatic cylinder 31. The connecting member 37 extends between the pivot lever 38 and the actuating element 36 approximately in height direction H. In doing so, said connecting member may also subtend an acute angle of 10° to 15° with the height direction H. As a result of this, the connecting member 37 may exert no or only a minimal force in longitudinal direction L on the piston of the first pneumatic cylinder 31 when the tail stock arm 16 is in working position A and a torque is applied to the tail stock arm 16 out of the working position A in the direction of the resting position R. Consequently, the first coupling arrangement 35 displays a self-locking feature in working position A of the tail stock arm 16. Consequently, the tail stock arm 16 must not be supported by a pneumatic force of the first pneumatic cylinder 31 in working position A. Due to the compressibility of the air, it would otherwise not be possible to achieve an exact positioning of the tail stock arm 16 and thus the support arrangement 11 or the centering tip 12.

Depending to which one of the working chambers in the first pneumatic cylinder 31 compressed air is applied, the tail stock arm 16 is held either in working position A or in resting position R or pivoted between these two positions A, R.

In working position A, the tail stock arm 16 is in contact with a stop 42. The stop 42 specifies the working position A. In the exemplary embodiment, it is associated with the inner end 16b of the tail stock arm 16. The stop 42 delimits the pivoting movement of the tail stock arm 16 out of the resting position R into the working position A, while it allows the unimpaired pivoting movement in opposite direction. Consequently, an undesirable pivoting movement of the tail stock arm 16 out of the working position A in a direction of rotation about the pivot axis S is prevented by the stop 42 and into the opposite direction of rotation by the above-described self-locking effect of the first coupling arrangement 35.

The first pneumatic cylinder 31, as well as the first coupling arrangement 35, are arranged—together with the tail stock arm 16—on the carriage 22 and can move with the carriage 22 in transverse direction Q relative to the base body 20.

For moving the carriage 22 along the base body 20 that can be mounted to the machine tool, there is provided a linear drive 45 that comprises a second pneumatic cylinder 46, as well as a second coupling arrangement 47. The second pneumatic cylinder 46 is arranged on the carriage 22 and can move in transverse direction Q—together with the carriage 22. The second pneumatic cylinder 46 is configured as a double-acting cylinder.

A relative movement can be generated between the carriage 22 and the base body 20 via the second coupling arrangement 47 when a piston of the second pneumatic cylinder 46 is moved. In accordance with the example, the second pneumatic cylinder 46 is arranged parallel to the first pneumatic cylinder 31, so that the piston of the second pneumatic cylinder 46 can move in longitudinal direction L in the cylinder housing. The piston of the second pneumatic cylinder 46 is connected to a piston rod 48 of the second pneumatic cylinder 46, said piston rod projecting from the cylinder housing and its free end being connected to a gate part 49. The gate part 49 and the piston rod 48 cannot be moved relative to each other in longitudinal direction L. The gate part 49 and the piston rod 48 can be moved together and, in the exemplary embodiment, have only one degree of freedom in longitudinal direction L.

The gate part 49 is movably guided in longitudinal direction L via two guide rails 50 extending parallel to each other in longitudinal direction L. Each of the two guide rails 50, together with the gate part 49, can form an anti-friction bearing and, in accordance with the example, a cross roller bearing (FIGS. 5 and 6). The guide rails 50 are fastened to the carriage 22. Consequently, the gate part 49 can be slid in longitudinal direction L relative to the carriage 22 by an appropriate application of pressure to the second pneumatic cylinder 46.

A slotted gate 51 is provided in the slotted gate part 49, said slotted gate being eliminated by two gate surfaces 52 extending parallel to each other. The two gate surfaces 52 can be formed by the groove flanks of a groove in the gate part 49 or—as in the exemplary embodiment shown here—by the opposing lateral walls of a slit 53 that extends through the gate part 49. The slotted gate 51 or the two gate surfaces 52 define a gate path along which a gate element 54 and the gate part 49 can be moved relative to each other. In the exemplary embodiment, the gate path is straight parallel to the two gate surfaces 52 or parallel to the slotted gate 51. The gate path is inclined relative to longitudinal direction L at an angle of inclination α (FIGS. 5 and 6). According to the example, the angle of inclination α is clearly smaller than 45° and is, preferably, at most 30° or at most 20°. In the exemplary embodiment, the angle of inclination α is 10°.

The gate element 54 is immovably connected to the base body 20. In accordance with the example said gate element has a pin that extends in height direction H away from the base body 20. In order to reduce wear and friction a sleeve 56 may be arranged coaxially with respect to the pin 55 on the section of the pin 55 that extends through or into the slotted gate 51. In the exemplary embodiment, the sleeve 56 is arranged so as to be rotatable about the axis of the pin 55. The outside diameter of the sleeve 56 is slightly smaller than the distance between the two gate surfaces 52 so that the sleeve 56 is arranged with the smallest possible play in the slotted gate 51 and is only in contact with one gate surface 52, respectively.

The gate element 54 or the pin 55 extends through a passage opening 57 in the carriage 22 (FIGS. 5 and 6). The passage opening 57 has a sufficiently large size in transverse direction Q so that the movement of the carriage 22 relative to the base body 20 is not impaired by the gate element 54. The gate element 54 or the pin 55—together with the passage opening 57—can define the two maximum positions of movement of the carriage 22 relative to the base body 20 and, so to speak, represent a movement limitation in the form of a stop. The passage opening 57 may be configured, for example, in the form of an elongated hole extending in transverse direction Q.

If pressure is applied to one of the two working chambers of the double-active second pneumatic cylinder 46 of the linear drive 56, it piston rod 48 moves into the cylinder housing or out of the cylinder housing, and the gate part 49 moves—together with the piston rod 48—in longitudinal direction L relative to the carriage 22. In doing so, the gate part 49 is supported by the gate element 54 that is arranged on the base body 20 so as to be immovable at least in longitudinal direction L and in transverse direction Q. The direction of movement of the relative movement between the gate part 49 and the gate element 54 is specified by the gate path that occurs at an angle of inclination α obliquely with respect to longitudinal direction L (within the plane formed by longitudinal direction L and transverse direction Q). The gate part 49 cannot move relative to the carriage 22 in transverse direction Q. The stroke of the piston of the second pneumatic cylinder 46 is reduced by the second coupling arrangement 47 into a linear movement of the carriage 22 relative to the base body 20. Due to this movement of the carriage 22 in transverse direction Q along the base body 20, it is possible to move the tail stock arm 16 toward and away from a workpiece, for example. The axis of the centering tip 12 extends parallel to the pivot axis S and, in accordance with the example, in transverse direction Q. Consequently, it is possible via the movement of the carriage 22, to bring the centering tip 12 into engagement with a work piece or press it against the workpiece or remove it from the workpiece.

Because of the dimensionally small angle of inclination α of 10°, for example, a sufficiently great force can be applied to the tail stock arm 16 via the second pneumatic cylinder 46, wherein said force can be used to move or push the tail stock arm 16 or the support arrangement 11 against the workpiece. The force with which the second pneumatic cylinder 46 is made available in longitudinal direction L is translated by the second coupling arrangement 47 into a force with which the support arrangement 11 or the centering tip 12 can be pushed against a workpiece in transverse direction Q. Due to this translation of force and the reduction of the path of the second coupling arrangement 47, it is possible to avoid shock-like movements while pressure is being applied to one work chamber of the second pneumatic cylinder 46, and sufficient force of pressure is achieved between the support arrangement 11 and the workpiece.

As is shown in FIG. 1 the tail stock device 10 comprises a cover that is fastened to the carriage 22. The cover 60 covers the pivot drive 30 and the linear drive 45 and prevents shavings falling off the workpiece from getting into the region of two parts that can be moved relative to each other.

The invention relates to a tail stock device 10 for supporting a workpiece in a machine tool, for example a grinding machine. The tail stock device 10 comprises a tail stock arm 16 that is pivotally supported about a pivot axis S, said tail stock arm having arranged on its outer end 16a a centering tip 12 that is oriented parallel to the pivot axis S. By means of a pivot drive 30 comprising a first pneumatic cylinder 31, the tail stock arm 16 can be pivoted between a working position A and a resting position R. The movement of the piston 32 of the first pneumatic cylinder 31 is transmitted—via a first coupling arrangement 35—to the tail stock arm 16. When the tail stock arm 16 is in working position A, the first coupling arrangement 35 assumes a self-locking position in which a force feedback effect being triggered by a torque that forces the tail stock arm 16 out of working position A and into resting position R does not or only minimally retroact on the piston 32 of the first pneumatic cylinder 31.

### LIST OF REFERENCE SIGNS

10 Tail stock device
11 Support arrangement
12 Centering tip
15 Carrier arrangement
16 Tail stock arm
16a Outer end of the tail stock arm
16b Inner end of the tail stock arm
20 Base body
21 Mounting arrangement
22 Carriage
23 Guiding arrangement
24 Rail guide
28 Shaft
29 Pivot bearing body
30 Pivot drive
31 First pneumatic cylinder
32 Piston of the first pneumatic cylinder
33 Piston rod
34 Actuating element
35 First coupling arrangement
36 Actuating element
37 Connecting member
38 Pivot lever
39 First hinge
40 Second hinge
41 Guiding recess
42 Stop
45 Linear drive
46 Second pneumatic cylinder
47 Second coupling arrangement
48 Piston rod
49 Gate part
50 Guide rails
51 Slotted gate
52 Gate surface
53 Slit
54 Gate element
55 Pin
56 Sleeve
57 Passage opening
60 Cover
α Angle of inclination
A Working position
H Height direction
L Longitudinal direction
Q Transverse direction
R Resting position
S Pivot axis

1-15. (canceled)

16. Tail stock device for supporting and/or centering a workpiece, comprising:
a carrier arrangement that is disposed to be connected to a machine tool;
a tail stock arm arranged on the carrier arrangement, said tail stock arm being supported on an inner end so as to be pivotable about a pivot axis (S) and bearing, on the outer end opposite the inner end, a support arrangement; and
a pivot drive having a first pneumatic cylinder and a first coupling arrangement, in which case a piston of the first pneumatic cylinder is movably coupled with the inner end of the tail stock arm via the first coupling arrangement,
wherein the tail stock arm can be moved by means of the pivot drive between a working position (A) and a resting position (R), and wherein the first coupling arrangement reduces a force feedback effect on the first pneumatic cylinder when a torque about the pivot axis (S) acting on the tail stock arm in the working position (A) of said tail stock arm occurs.

17. Tail stock device according to claim 16, wherein the first coupling arrangement includes a pivot lever connected in a torque-proof manner to the inner end and extending from the pivot axis (S) to a lever end, and the tail stock device further comprising a connecting member rotatably connected to the lever end by means of a first hinge and rotatably connected to an actuating element by means of a second hinge, in which case the actuating element is connected to the piston of the first pneumatic cylinder.

18. Tail stock device according to claim 17, wherein with the tail stock arm in the working position (A), the connecting member is oriented substantially at a right angle with respect to a longitudinal direction (L) in which the actuating element can move.

19. Tail stock device according to claim 17, wherein with the tail stock arm in the working position (A), the connecting member is oriented substantially at a right angle with respect to the actuating element.

20. Tail stock device according to claim 17, wherein with the tail stock arm in the working position (A), the connecting member is oriented substantially parallel to the tail stock arm.

21. Tail stock device according to claim 17, wherein the actuating element is arranged so as to be slidable in a longitudinal direction (L).

22. Tail stock device according to claim 16, wherein the tail stock arm is forced, when in working position (A), against a stop by means of the pivot drive.

23. Tail stock device according to claim 16, wherein the carrier arrangement includes a base body that is disposed for the connection with the machine tool, and wherein a carriage is arranged so as to be slidable on the base body.

24. Tail stock device according to claim 23, wherein the tail stock arm and the pivot drive are arranged on the carriage.

25. Tail stock device according to claim 23, further comprising a linear drive including a second pneumatic cylinder and a second coupling arrangement, and being disposed to slide and/or position the carriage relative to the base body.

26. Tail stock device according to claim 25, wherein the second coupling arrangement includes a gate part with a slotted gate defining a gate path, along which a gate element is arranged so as to be movable relative to the gate part.

27. Tail stock device according to claim 26, wherein the second pneumatic cylinder includes a piston that can be moved in a longitudinal direction (L), and that the carriage can be moved in a transverse direction (Q) oriented at a right angle with respect to longitudinal direction (L).

28. Tail stock device according to claim 27, wherein the gate path extends obliquely to longitudinal direction (L) and to transverse direction (Q).

29. Tail stock device according to claim 28, wherein the gate path subtends an angle of inclination (α) with longitudinal direction (L), said angle being smaller than 45°.

30. Tail stock device according to claim 28, wherein the gate path subtends an angle of inclination (α) with longitudinal direction (L), said angle being at most 30°.

31. Tail stock device according to claim 28, wherein the gate path subtends an angle of inclination (α) with longitudinal direction (L), said angle being at most 20°.

32. Tail stock device according to claim 25, wherein the second pneumatic cylinder is arranged on the carriage.
